(19) United States
(12) Patent Application Publication
(10) Pub. No.: US 2017/0251811 A1
(43) Pub. Date: Sep. 7, 2017

(54) OVERTURN PREVENTING DEVICE

(71) Applicant: KYB CORPORATION, Minato-ku Tokyo (JP)

(72) Inventors: Shinichi SEKINE, Minato-ku, Tokyo (JP); Eiro FUJITA, Minato-ku, Tokyo (JP); Yasushi SAITO, Hanishina-gun (JP); Masanori OGURA, Minato-ku, Tokyo (JP); Teruhiko INOUE, Minato-ku, Tokyo (JP); Kenji ISSHIN, Minato-ku, Tokyo (JP); Keita ABE, Minato-ku, Tokyo (JP)

(73) Assignee: KYB CORPORATION, Minato-ku, Tokyo (JP)

(21) Appl. No.: 15/501,120

(22) PCT Filed: Jul. 31, 2015
(86) PCT No.: PCT/JP2015/071759

§ 371 Date: Feb. 1, 2017

(30) Foreign Application Priority Data
Aug. 6, 2014 (JP) 2014-160505

(51) Int. Cl. A47B 97/00; F16F 9/516; F16F 9/16

(52) U.S. Cl. CPC A47B 97/00; F16F 9/16; F16F 9/516; A47B 2097/008; F16F 2222/12; F16F 2232/08; F16F 2236/04

(57) ABSTRACT

Providing an overturn preventing device which can be mounted to an article such as furniture irrespective of an installation location of the article and which can prevent the article from being overturned by quakes of an earthquake or the like. The overturn preventing device includes a plurality of dampers mounted between a top surface of the furniture installed on a floor surface and a ceiling. The dampers are compression damper that has a smaller damping force generated during an extending operation than a damping force generated during a compressing operation. The dampers have respective axis lines extending from a ceiling side to the top surface side of the furniture, and the axis lines are downwardly inclined and extend in a plurality of directions in a planar view as viewed from above when the dampers are mounted between the top surface of the furniture and the ceiling.

### TECHNICAL FIELD

The present invention relates to an overturn preventing device.

### BACKGROUND ART

Patent Document 1 discloses a conventional overturn preventing device. This overturn preventing device includes a wall side locking implement connected to a wall surface, a furniture side locking implement connected to a piece of furniture and an overturn preventing device body interposed between both locking implements. The overturn preventing device body includes a damper and a length adjuster provided in series to the damper. The damper is of a unidirectional type in which a damping force generated during an extending operation is larger than a damping force generated during a compressing operation. The furniture side locking implement is connected to a top surface of the furniture arranged near a wall surface vertically standing from a floor surface, and the wall side locking implement is connected to a wall surface located above the top surface of the furniture. The overturn preventing device is thus mounted between the furniture and the wall surface, so that when quakes of an earthquake or the like tilts the furniture in a direction such that an upper part of the furniture separates from the wall surface, the damper extends to generate a damping force, thereby damping a force tilting the furniture. As a result, the overturn preventing device can prevent the furniture from being overturned while damping shock applied to the wall side locking implement and the furniture side locking implement.

### PRIOR ART DOCUMENT

### Patent Documents

Patent Document 1: Japanese Patent Application Publication No. JP-A-2011-161085

### SUMMARY OF THE INVENTION

### Problem to be Overcome by the Invention

However, the overturn preventing device of Patent Document 1 can be mounted only to the furniture arranged near the wall surface since the wall side locking implement is connected to the wall surface.

The present invention was made in view of the above-described circumstances in the conventional art and provides an overturn preventing device which can be mounted to an article such as furniture irrespective of an installation location of the article and which can prevent the article from being overturned by quakes of an earthquake or the like.

### Means for Overcoming the Problem

An overturn preventing device of a first invention includes a plurality of dampers mounted between a top surface of an article installed on an installation surface and a ceiling. These dampers are of either a type that has a smaller damping force generated during an extending operation than a damping force generated during a compressing operation (hereinafter referred to as “compression damper”) or a type that has a larger damping force generated during the extending operation than a damping force generated during the compressing operation (hereinafter referred to as “extension damper”). These dampers have respective axis lines extending from a ceiling side to the top surface side of the article, and the axis lines are downwardly inclined and extend in a plurality of directions in a planar view as viewed from above when the dampers are mounted between the top surface of the article and the ceiling.

An overturn preventing device of a second invention includes a plurality of dampers mounted between a top surface of an article installed on an installation surface and a ceiling. These dampers include compression dampers and extension dampers. Furthermore, these dampers have respective axis lines extending from a ceiling side to the top surface side of the article, and the axis lines are downwardly inclined and extend in an identical direction in a planar view as viewed from above when the dampers are mounted between the top surface of the article and the ceiling.

An overturn preventing device of a third invention includes a plurality of dampers mounted between a top surface of an article installed on an installation surface and a ceiling. Each damper generates a first damping force during an extending operation and a second damping force during a compressing operation, which first and second damping forces are equal to each other (hereinafter referred to as “bidirectional damper”). Furthermore, these dampers have respective axis lines extending from a ceiling side to the top surface side of the article, and the axis lines are downwardly inclined when the dampers are mounted between the top surface of the article and the ceiling. Here, that the damping forces generated during the extending operation and the compressing operation of the dampers are equal to each other includes a case where the damping forces are substantially equal to each other as well as a case where the damping forces are completely equal to each other.

In the overturn preventing device of the first invention, when the dampers are mounted between the top surface of the article and the ceiling, the axis lines may extend from the ceiling side to the top surface side of the article in line symmetry.

Furthermore, in the overturn preventing device of the first invention, when the dampers are mounted between the top surface of the article and the ceiling, the axis lines may extend from the ceiling side to the top surface side of the article in point symmetry.

In the overturn preventing device of each of the first to third inventions, the overturn preventing device may further include a base having an abutting surface which is brought into surface contact with the top surface of the article or the ceiling, and the base is connected to an end of each damper with the axis line of each damper being inclined relative to the abutting surface.

The article includes furniture, a bed having a plurality of beds connected to each other in the up-down direction, large sized televisions, refrigerators, book shelves, showcases and server racks, all of which have a possibility of being overturned by quakes of earthquake or the like. The installation surface includes not only floor surfaces located inside buildings but also foundation surfaces which are located outside buildings and on which articles are installed.

### BRIEF DESCRIPTION OF THE DRAWINGS

FIG. 1 is a side elevation of the overturn preventing device of a first embodiment, mounted between a top surface of furniture and the ceiling;

FIG. 2 is a plan view of the overturn preventing device of the first embodiment, mounted between the top surface of the furniture and the ceiling, as viewed from above;

FIG. 3 is a schematic view of a compression damper;

FIG. 4 is a side elevation of the overturn preventing device of a second embodiment, mounted between the top surface of the furniture and the ceiling;

FIG. 5 is a plan view of the overturn preventing device of the second embodiment, mounted between the top surface of the furniture and the ceiling, as viewed from above;

FIG. 6 is a schematic view of an extension damper;

FIG. 7 is a schematic view of a bidirectional damper;

FIG. 8 is a plan view of the overturn preventing device mounted between the top surface of the furniture and the ceiling with a plurality of damper axis lines extending in line symmetry, as viewed from above;

FIG. 9 is a plan view of the overturn preventing device mounted between the top surface of the furniture and the ceiling with a plurality of damper axis lines extending in point symmetry, as viewed from above (No. 1);

FIG. 10 is a plan view of the overturn preventing device mounted between the top surface of the furniture and the ceiling with a plurality of damper axis lines extending in point symmetry, as viewed from above (No. 2);

FIG. 11 is a plan view of the overturn preventing device provided with a combination base; and

FIG. 12 is a side elevation of the overturn preventing device mounted between the top surface of the furniture and the ceiling, in which device two dampers are connected between a single first base and a single second base.

### BEST MODE FOR CARRYING OUT THE INVENTION

First and second embodiments of the overturn preventing devices of first to third inventions will be described with reference to the drawings.

### First Embodiment

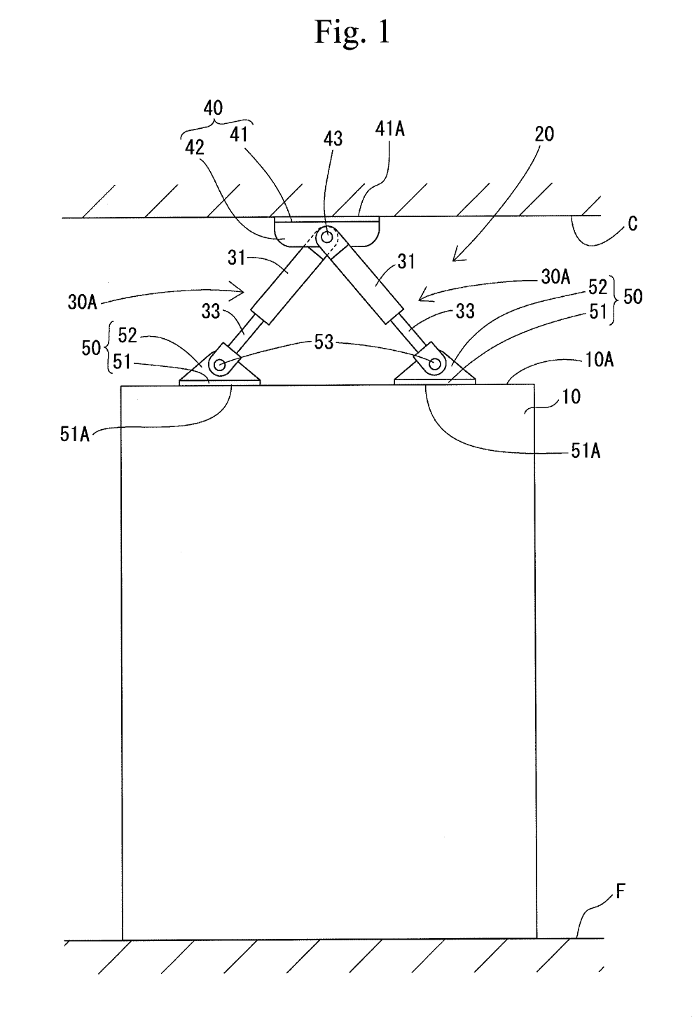

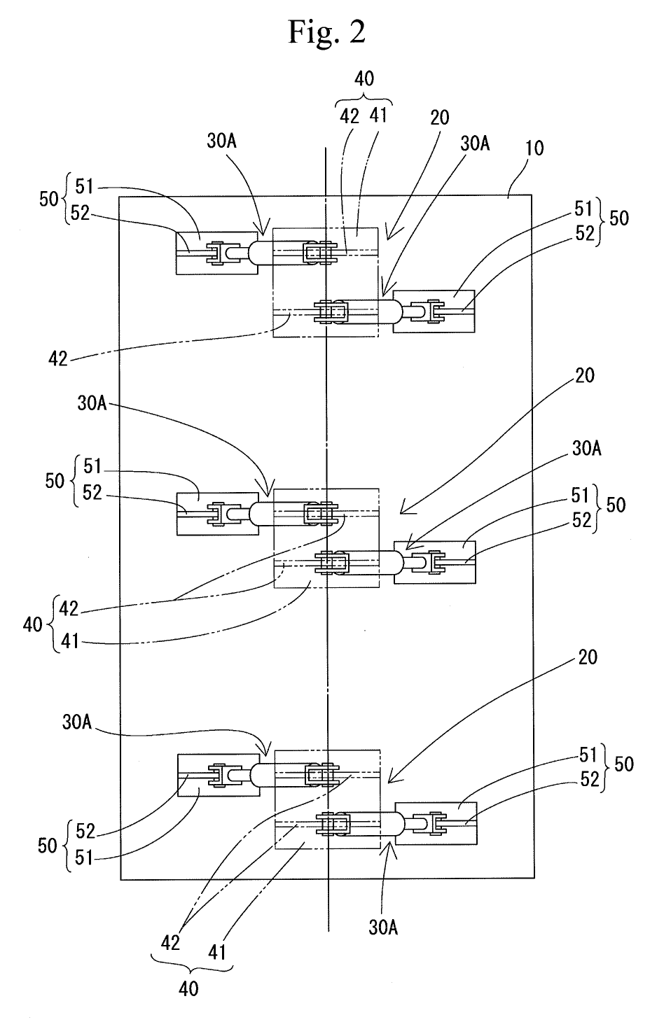

The overturn preventing device 20 of the first embodiment is mounted between a top surface of furniture 10 installed on a floor surface F and a ceiling C and prevents the furniture 10 from being overturned by a quake of earthquake or the like, as illustrated in FIGS. 1 and 2. The furniture 10 is formed into a cuboid shape and has a door, drawers (neither shown) and the like in a front, so that clothes, accessories and the like can be housed in the furniture 10. The furniture 10 has a rectangle-shaped horizontal section long in a right-left direction (a depthwise direction in FIG. 1, an up-down direction in FIG. 2 and the same shall apply hereinafter). When the overturn preventing device 20 is not mounted to the furniture 10, the furniture 10 would possibly be tilted in a front-back direction (the right-left direction in FIGS. 1 and 2 and the same shall apply hereinafter) by a quake of earthquake or the like thereby to be overturned.

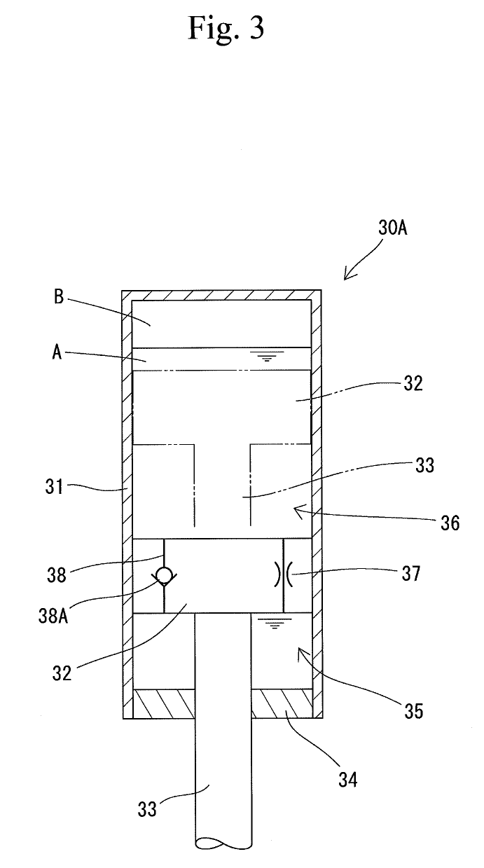

The overturn preventing device 20 comprises a set of two compression dampers 30A. Each compression damper 30A has a cylinder 31, a piston 32, a rod 33 and a rod guide 34, as illustrated in FIG. 3. The cylinder 31 has a bottomed cylindrical shape. The rod guide 34 closes an opening of the cylinder 31. The piston 32 is slidably inserted into the cylinder 31. The rod 33 has a proximal end connected to the piston 32 and extends through the rod guide 34. The rod 33 has a distal end side protruding out of the cylinder 31. An operating oil A and a gas B are enclosed in the cylinder 31.

Each compression damper 30A is set so that a damping force generated during an extending operation is smaller than a damping force generated during a compressing operation. The extending operation of each compression damper 30A refers to an operation which increases an amount of protrusion of the rod 33 out of the cylinder 31 and an entire length of each compression damper 30A. On the other hand, the compressing operation of each compression damper 30A refers to an operation which reduces an amount of protrusion of the rod 33 out of the cylinder 31 and the entire length of each compression damper 30A.

A mechanism that each compression damper 30A generates a damping force will be described. The cylinder 31 has an interior divided by the piston 32 into a rod side pressure chamber 35 in which the proximal end of the rod 33 is housed and a counter-rod side pressure chamber 36. The piston 32 is formed with an orifice 37 which is a throttle valve communicating between both pressure chambers 35 and 36 of the piston 32. The orifice 37 functions as a damping force generator which applies resistance to a flow of the operating oil A between the rod side pressure chamber 35 and the counter-rod side pressure chamber 36 with the extending/compressing operation of each compression damper 30A. Furthermore, the piston 32 is formed with a communication path 38 communicating via a check valve 38A with both pressure chambers 35 and 36. The check valve 38A allows the operating oil A to flow from the rod side pressure chamber 35 to the counter-rod side pressure chamber 36 and blocks reverse flow of the operating oil A. Accordingly, each compression damper 30A has two flow paths of the operating oil A from the rod side pressure chamber 35 to the counter-rod side pressure chamber 36 during the extending operation, that is, one flow path including the orifice 37 and the other flow path including the communication path 38. On the other hand, each compression damper 30A has only one flow path of the operating oil A from the counter-rod side pressure chamber 36 to the rod side pressure chamber 35 through the orifice 37 during the compressing operation. Accordingly, the damping force generated by each compression damper 30A during the extending operation is smaller than the damping force generated by each compression damper 30A during the compressing operation.

The overturn preventing device 20 includes two compression dampers 30A, one first base 40 and two second bases 50 as illustrated in FIGS. 1 and 2. The first base 40 includes a flat plate-shaped first base portion 41 having an abutting surface 41A brought into surface contact with the ceiling C and a pair of flat plate-shaped first connecting portions 42 which are perpendicular to a side of the first base portion 41 opposed to the abutting surface 41A. The paired first connecting portions 42 are spaced from each other and extend in parallel to each other. The paired first connecting portions 42 have first shafts 43 to which are connected proximal ends of the cylinders 31 of two compression dampers 30A and which are located at middle portions of the first connecting portions 42 on a common straight line, respectively. Each compression damper 30A extends along an extending direction of the first connecting portion 42, while being inclined at a predetermined angle relative to the abutting surface 41A so that an axis line of each compression damper 30A departs from the first base portion 41. Furthermore, the compression dampers 30A are connected respectively to the paired first connecting portions 42 of the first base 40 while being inclined in opposite directions to each other. More specifically, the proximal ends of two cylinders 31 are connected to the first base 40 while the respective axis lines of the compression dampers 30A are inclined relative to the abutting surface 41A.

Each second base 50 includes a flat plate-shaped second base portion 51 having an abutting surface 51A brought into surface contact with the top surface 10A of the furniture 10 and a flat plate-shaped second connecting portion 52 which is perpendicular to a surface opposed to the abutting surface 51A of the second base portion 51. The distal end of the rod 33 of each compression damper 30A is connected to the second connecting portion 52 by a second shaft 53 parallel to the first shafts 43 so that each compression damper 30A is rotatable relative to the second connecting portion 52.

The abutting surfaces 41A of the first bases 40 are brought into surface contact with the ceiling C so that the first shafts 43 of the first bases 40 are located above the vicinities of the middle of the furniture 10 in a direction such that the furniture 10 installed on the floor surface F is tilted by quakes of an earthquake or the like, that is, in the front-back direction, whereby the first bases 40 are fixed to the ceiling C. When the first bases 40 are thus fixed to the ceiling C, the axis lines of the compression dampers 30A are downwardly inclined from the first bases 40, and the abutting surfaces 51A of the second base portions 51 of the second bases 50 abut against front and rear ends of the top surface 10A of the furniture 10, respectively. In this case, the second bases 50 are connected to the distal ends of the rods 33 of the compression dampers 30A extending in the front-back direction of the furniture 10, respectively. The second bases 50 are fixed to these positions (the front end and the rear end of the top surface 10A of the furniture 10). Thus, three overturn preventing devices 20 are mounted between the top surface 10A of the furniture 10 and the ceiling C at regular intervals in the right-left direction of the furniture 10 (see FIG. 2). More specifically, in each overturn preventing device 20, while the abutting surface 41A of the first base portion 41 is in surface contact with the ceiling C, the axis line of each compression damper 30A is downwardly inclined relative to the abutting surfaces 41A of the first base portion 41 toward the top surface 10A of the furniture 10 (the axis line of each compression damper 30A extending from the ceiling C side to the top surface 10A side of the furniture 10 is downwardly inclined), extending in opposite directions (two directions) as viewed from above in a planar view.

When the furniture 10 to which the overturn preventing devices 20 are thus mounted is moved in the front-back direction by quakes of an earthquake or the like thereby to be tilted frontward, the three compression dampers 30A extending from the first base 40 in surface contact with the ceiling C toward the front edge of the furniture 10 each perform a compressing operation, exerting a damping force. Accordingly, a force tilting the furniture 10 frontward is damped by the compression dampers 30A with the result that an amount of frontward tilt is suppressed. On the other hand, when the furniture 10 is moved by quakes of an earthquake thereby to be tilted rearward, the three compression dampers 30A extending from the base 40 toward the front edge of the furniture 10 each perform a compressing operation, exerting a damping force. Accordingly, a force tilting the furniture 10 rearward is damped by the compression dampers 30A with the result that an amount of rearward tilt is suppressed.

Thus, when the furniture 10 is tilted by the quakes of the earthquake in the extending direction of the axis line of each compression damper 30A, that is, in the front-back direction of the furniture 10, each compression damper 30A mounted between the top surface 10A of the furniture 10 installed on the floor surface F and the ceiling C performs the compressing operation to generate a damping force, so that a force tilting the furniture 10 is damped. Consequently, an amount of tilt of the furniture 10 is suppressed with the result that the furniture 10 can be prevented from being overturned. Furthermore, the overturn preventing device 20 can be mounted to a furniture 10 which is not installed near a wall surface vertically standing from the floor F, preventing the furniture 10 from being overturned.

Accordingly, the overturn preventing device 20 of the first embodiment can be mounted to the furniture 10 irrespective of an installation location of the furniture 10 and can prevent the furniture 10 from being overturned by the quakes of the earthquake.

Furthermore, when the first bases 40 are fixed to the ceiling C, the axis lines of the compression dampers 30A are inclined. As a result, the overturn preventing device 20 can easily be mounted between the upper surface of the furniture 10 and the ceiling C while the axis line of each compression damper 30A is inclined.

### Second Embodiment

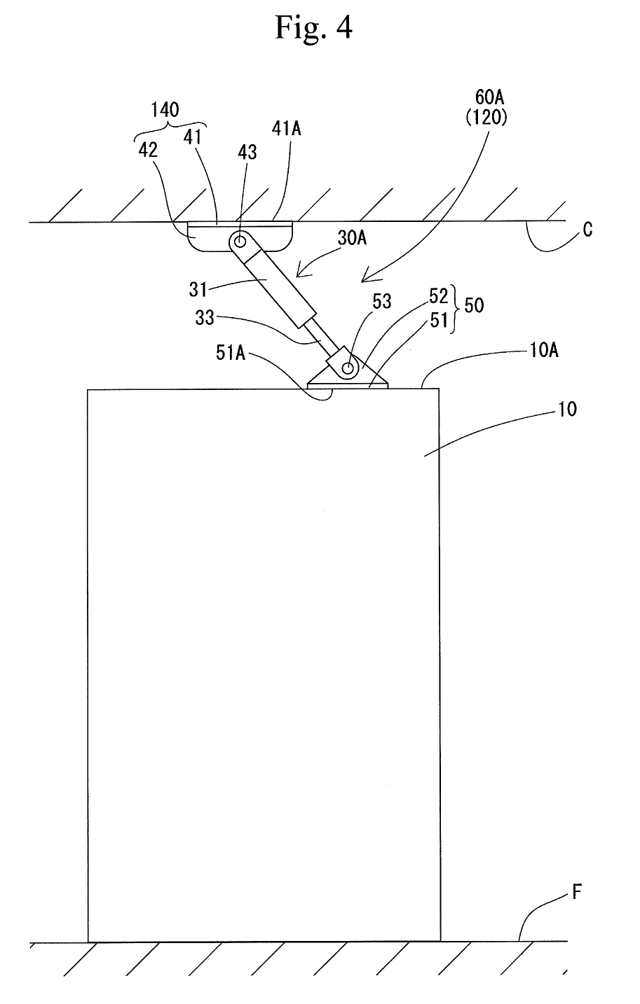

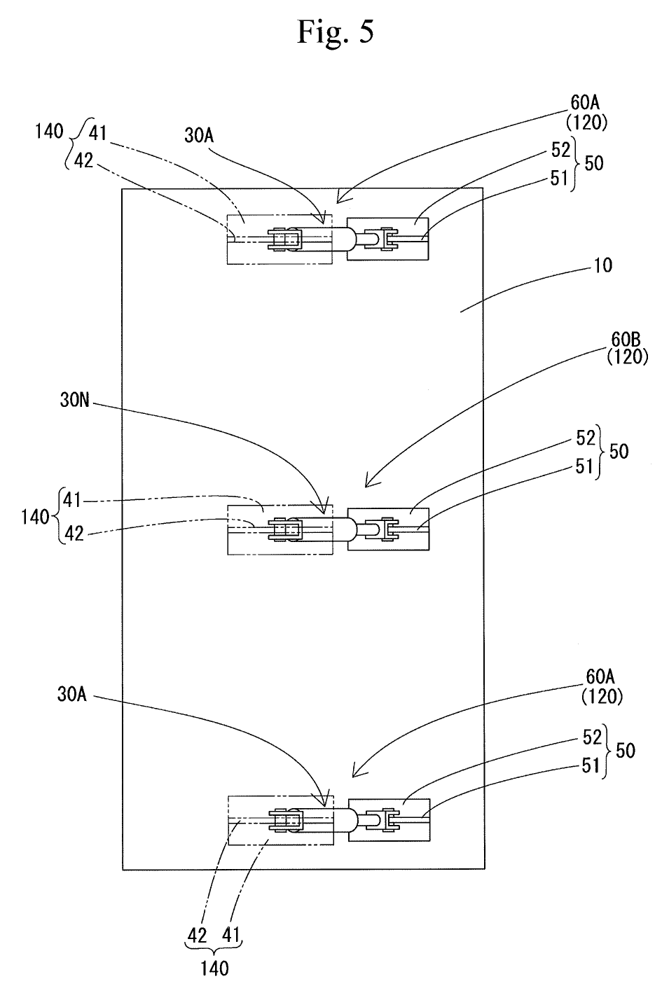

The overturn preventing device 120 of a second embodiment is mounted between the top surface 10A of the furniture 10 and the ceiling C in order to prevent the furniture 10 from being overturned by quakes of earthquake or the like, as illustrated in FIGS. 4 and 5. In the second embodiment, identical or similar construction is labelled by the same reference symbol as that in the first embodiment and the detailed description of such construction will be eliminated.

The overturn preventing device 120 comprises a plurality of damper units 60A and 60B which are composed into a set. More specifically, in the second embodiment, the overturn preventing device 120 comprises three damper units including two damper units 60A and one damper unit 60B, which damper units 60A and 60B are separately mounted between the top surface 10A of the furniture 10 and the ceiling C.

Each damper unit 60A, 60A and 60B includes one damper 30A or 30N, one first base 140 and one second base 50. The dampers incorporated into the respective damper units 60A, 60A and 60B are compression dampers 30A or extension dampers 30N. In the second embodiment, the dampers incorporated into the two damper units 60A mounted on the right and left ends of the top surface 10A of the furniture 10 are compression dampers 30A respectively, and the damper incorporated into the one damper unit 60B mounted on the middle of the top surface 10A of the furniture 10 in the right-left direction is an extension damper 30N.

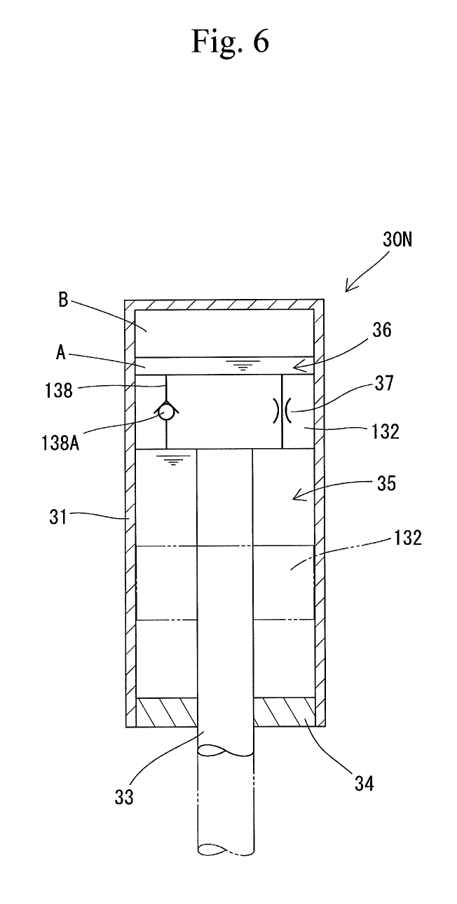

The extension damper 30N also includes a cylinder 31, a piston 132, a rod 33 and a rod guide 34 as illustrated in FIG. 6. The cylinder 31 is bottomed and is cylindrical in shape. The rod guide 34 closes an opening of the cylinder 31. The piston 32 is slidably inserted into the cylinder 31. The rod 33 has a proximal end connected to the piston 132 and a distal end side projecting through the rod guide 34 out of the cylinder 31. The operating oil A and the gas B are enclosed in the cylinder 31.

A mechanism that the extension damper 30N generates a damping force will be described. The cylinder 31 has an interior divided by the piston 132 into a rod side pressure chamber 35 in which the proximal end of the rod 33 is housed and a counter-rod side pressure chamber 36. The piston 32 is formed with an orifice 37 communicating between both pressure chambers 35 and 36 of the piston 32. The orifice 37 functions as a damping force generator which applies resistance to a flow of the operating oil A between rod side pressure chamber 35 and the counter-rod side pressure chamber 36 with the extending/compressing operation of the extension damper 30N. Furthermore, the piston 32 is formed with a communication path 138 communicating between both pressure chambers 35 and 36 via a check valve 138A. The check valve 138A allows the operating oil A to flow from the counter-rod side pressure chamber 36 to the rod side pressure chamber 35 and blocks reverse flow of the operating oil A. Accordingly, the extension damper 30N has two flow paths of the operating oil A from the counter-rod side pressure chamber 36 to the rod side pressure chamber 35 during the compressing operation, that is, one flow path including the orifice 37 and the other flow path including the communication path 138. On the other hand, the extension damper 30N has only one flow path of the operating oil A from the rod side pressure chamber 35 to the counter-rod side pressure chamber 36 through the orifice 37 during the extending operation. Accordingly, the damping force generated by the extension damper 30N during the extending operation is larger than the damping force generated by the extension damper 30N during the compressing operation.

The first base 140 includes a flat plate-shaped first base portion 41 having an abutting surface 41A surface contacting the ceiling C and a flat plate-shaped first connecting portion 42 perpendicular to a surface of the first base portion 41 located opposite the abutting surface 41A, as illustrated in FIGS. 4 and 5. The cylinders 31 of the dampers 30A and 30N have proximal ends connected by the first shafts 43 to the first connecting portions 42 respectively. The dampers 30A and 30N extend along an extending direction of the first connecting portions 42 while inclined at predetermined angles relative to the abutting surfaces 41A so that axis lines of the dampers 30A and 30N depart from the first base portions 41 respectively.

The second base 50 includes a flat plate-shaped second base portion 51 having an abutting surface 51A which is brought into surface contact with the top 10A of the furniture 10 and a flat plate-shaped second connecting portion 52 which extends perpendicular to a surface of the second base portion 51 located opposite the abutting surface 51A. The rods 33 of the dampers 30A and 30N have distal ends connected by second shafts 53 parallel to the first shaft 43 so that the dampers 30A and 30N are rotatable relative to the second connecting portions 52, respectively.

The overturn preventing device 120 comprises two damper units 60A into which are incorporated compression dampers 30A mounted between right and left ends of the top surface 10A and the ceiling C and one damper unit 60B into which is incorporated an extension damper 30N mounted between the middle of the top surface 10A and the ceiling C, as described above.

The damper units 60A and 60B are fixed while the abutting surfaces 41A of the first base portions 41 of the first bases 140 are brought into surface contact with the ceiling C so that the first shafts 43 of the first bases 140 are located above the vicinities of the middle of the furniture 10 in a direction such that the furniture 10 installed on the floor surface F is tilted by quakes of an earthquake or the like, that is, in the front-back direction of the furniture 10. When the first bases 140 are thus fixed to the ceiling C, axis lines of the dampers 30A and 30N are downwardly inclined, and the abutting surfaces 51A abut against a rear end of the top surface 10A of the furniture 10. In this case, the second bases 50 are connected to the distal ends of the rods 33 of the dampers 30A and 30N respectively. The second bases 50 are fixed to the rear end of the top surface 10A of the furniture 10. Thus, the three damper units 60A and 60B are mounted between the top surface 10A of the furniture 10 and the ceiling C. More specifically, the axis lines of the dampers 30A and 30N are downwardly inclined toward the top surface 10A of the furniture 10 relative to the abutting surfaces 41A of the first base portions 41 while the abutting surfaces 41A are in surface contact with the ceiling C (the axis lines of the dampers 30A and 30N extending from the ceiling C side to the top surface 10A side of the furniture 10 are downwardly inclined), and the axis lines extend in the same direction in planar view as viewed from above.

Each of the dampers 30A and 30N performs the compressing operation when the furniture 10 to which the overturn preventing device 120 is mounted is moved in the front-back direction by quakes of an earthquake or the like thereby to be tilted frontward. Accordingly, the compression dampers 30A incorporated into the damper units 60A mounted on the right and left ends of the top surface 10A of the furniture 10, exert damping forces to damp a force frontwardly tilting the furniture 10, whereby an amount of frontward tilt is suppressed. On the other hand, each of the dampers 30A and 30N performs the extending operation when the furniture 10 is moved in the front-back direction by quakes of an earthquake or the like thereby to be tilted rearward. Accordingly, the extension damper 30N, which is incorporated into the damper unit 60B mounted on the middle of the top surface 10A of the furniture 10 in the right-left direction, exerts a damping force to damp a force rearwardly tilting the furniture 10, whereby an amount of frontward tilt is suppressed.

Thus, when the furniture 10 is tilted in the extending direction of the axis lines of the dampers 30A and 30N, that is, in the front-back direction thereof, each of the dampers 30A and 30N mounted between the top surface 10A of the furniture 10 and the ceiling C performs extending and compressing operations to generate a damping force, thereby damping the force inclining the furniture 10. As a result, an amount of tilt of the furniture 10 is suppressed, so that the furniture 10 can be prevented from being overturned. The overturn preventing device 120 can thus be mounted even to the furniture 10 which is not installed near the wall surface vertically standing from the floor surface F, preventing the furniture 10 from being overturned.

Accordingly, the overturn preventing device of the second embodiment can be mounted irrespective of the place where the furniture 10 is installed and can prevent an article from being overturned by quakes of an earthquake or the like.

Furthermore, since the axis lines of the dampers 30A and 30N are inclined when the first bases 140 are fixed to the ceiling C, the overturn preventing device 120 can easily be mounted between the top surface 10A of the furniture 10 and the ceiling C.

The present invention should not be limited to the first and second embodiments described above with reference to the drawings, but the technical scope of the invention encompasses the following embodiments, for example.

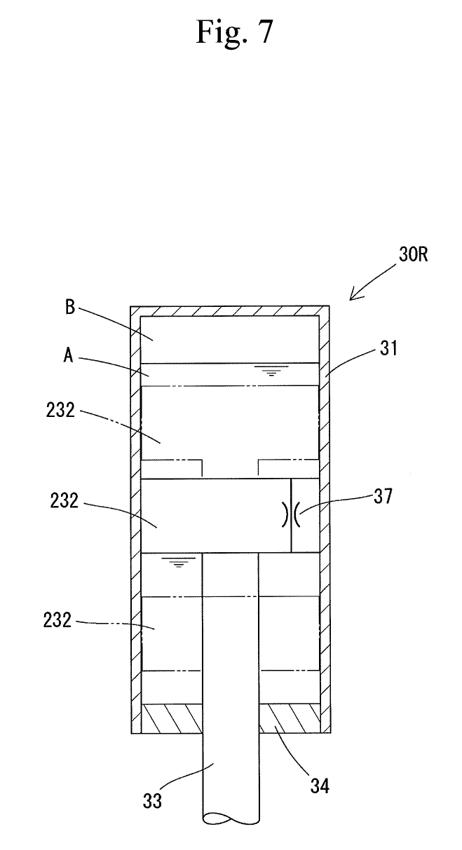

(1) Although the compression dampers 30A or the extension dampers 30N are incorporated into the overturn preventing device 20 and 120 in the first and second embodiments, a bidirectional (or dual direction) damper 30R as illustrated in FIG. 7 may be incorporated, instead. The bidirectional damper 30R includes a piston 232 which is formed with an orifice 37 but has no communication path through a check valve. The other construction of the bidirectional damper 30R is the same as the compression damper 30A or the extension damper 30N (identical or similar parts are labelled by the same reference symbols as those in the first or second embodiment and detailed description of these parts will be eliminated). Accordingly, a damping force generated during an extending operation by the bidirectional damper 30R is substantially equal to a damping force generated during a compressing operation by the bidirectional damper 30R. In this case, the damping force is generated during both the extending and the compressing operations. Accordingly, since a force tilting the furniture (the article) in the front-back direction is damped by the bidirectional dampers 30R, an amount of tilt of the furniture (the article) can be suppressed with the result that the furniture (the article) can be prevented from being overturned. Furthermore, since this overturn preventing device can also be mounted to the furniture (the article) which is not installed near the wall surface vertically standing from the floor surface, the furniture can be prevented from being overturned.

(2) Although the compression dampers 30A are incorporated into the overturn preventing device 20 in the first embodiment, the extension dampers 30N may be incorporated, instead. In this case, when the furniture (the article) is tilted frontward, the three extension dampers perform extending operations in which the extension dampers extend from the respective first bases in surface contact with the ceiling toward the front end of the furniture (the article) thereby to exert damping forces. Consequently, the force frontwardly tilting the furniture (the article) is damped with the result that an amount of frontward tilt is suppressed. On the other hand, when the furniture (the article) is tilted rearward, the three extension dampers perform extending operations in which the extension dampers extend from the respective first bases in surface contact with the ceiling toward the rear end of the furniture (the article) thereby to exert damping forces. Consequently, the force rearwardly tilting the furniture (the article) is damped with the result that an amount of rearward tilt is suppressed. The damping forces of the extension dampers thus act with the result that the furniture (the article) can be prevented from being overturned.

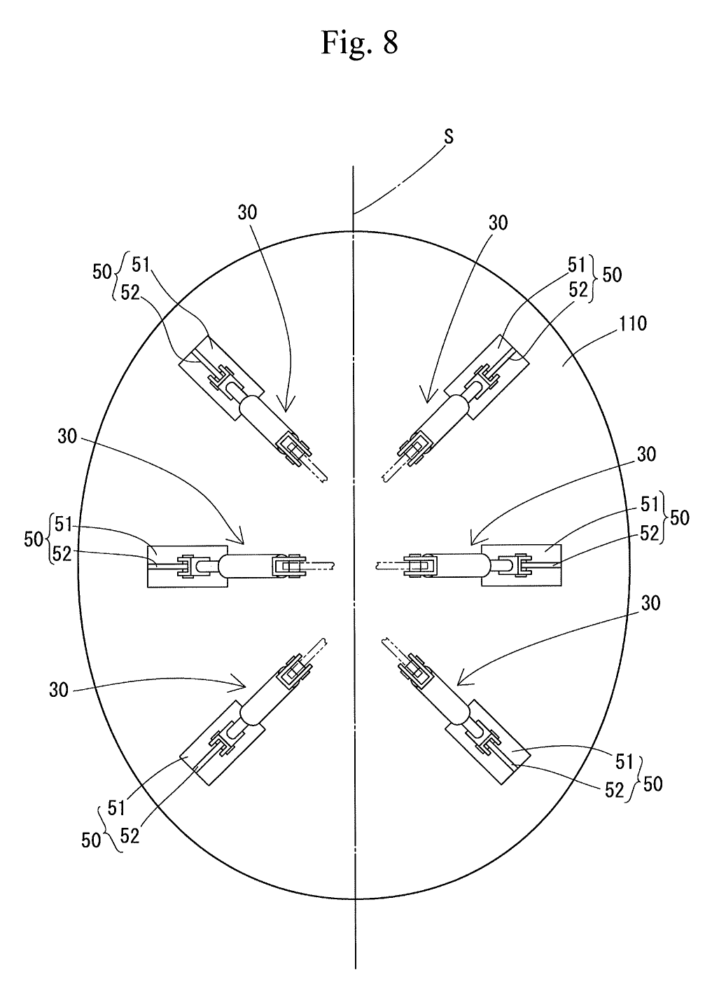

(3) In the first embodiment, the axis lines of the compression dampers 30A extending from the ceiling C side to the top surface 10A side of the furniture 10 extend in opposite directions (two directions) in a planar view as viewed from above. However, as illustrated in FIG. 8, the axis lines of the dampers 30 (the compression damper 30A, the extension damper 30B or the bidirectional damper 30R) may extend in different directions in line symmetry. In this case, when the furniture 110 (the article) is tilted in extending directions of the axis lines of the dampers 30 about a symmetric line S, the dampers 30 extend and compress thereby to generate damping forces, damping the forces tilting the furniture 110. Consequently, an amount of tilt of the furniture 110 (the article) is suppressed with the result that the furniture 110 (the article) can be prevented from being overturned. Thus, when a plurality of dampers 30 is mounted so that the axis lines extend in the different directions in line symmetry, the furniture 110 having an elliptic or other horizontal section (the article having a plurality of directions in which the article can be overturned) can desirably be prevented from being overturned.

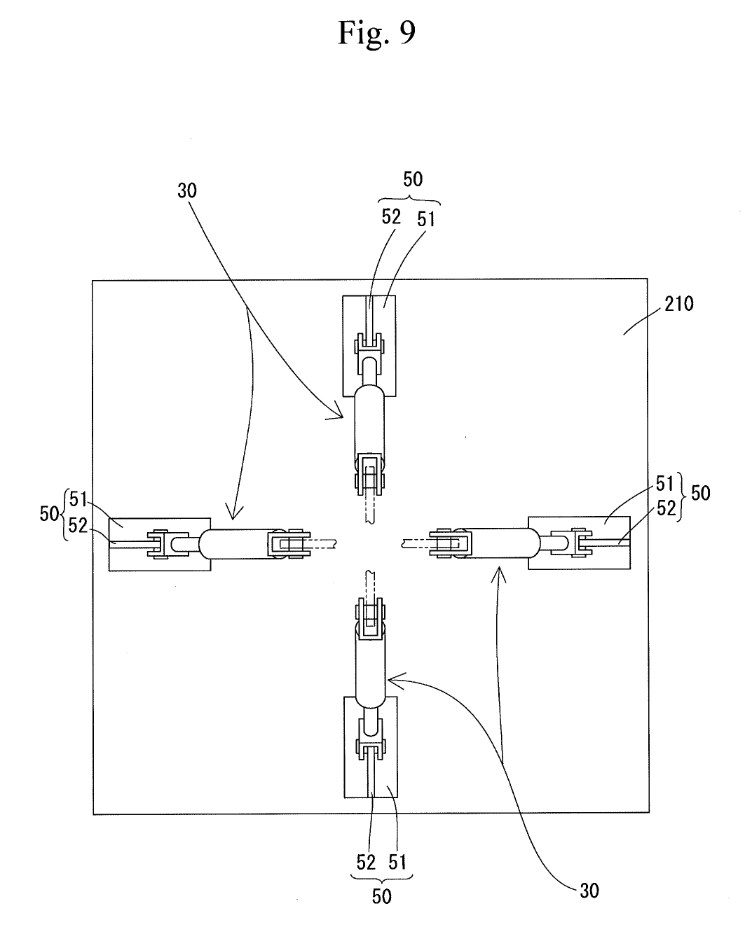

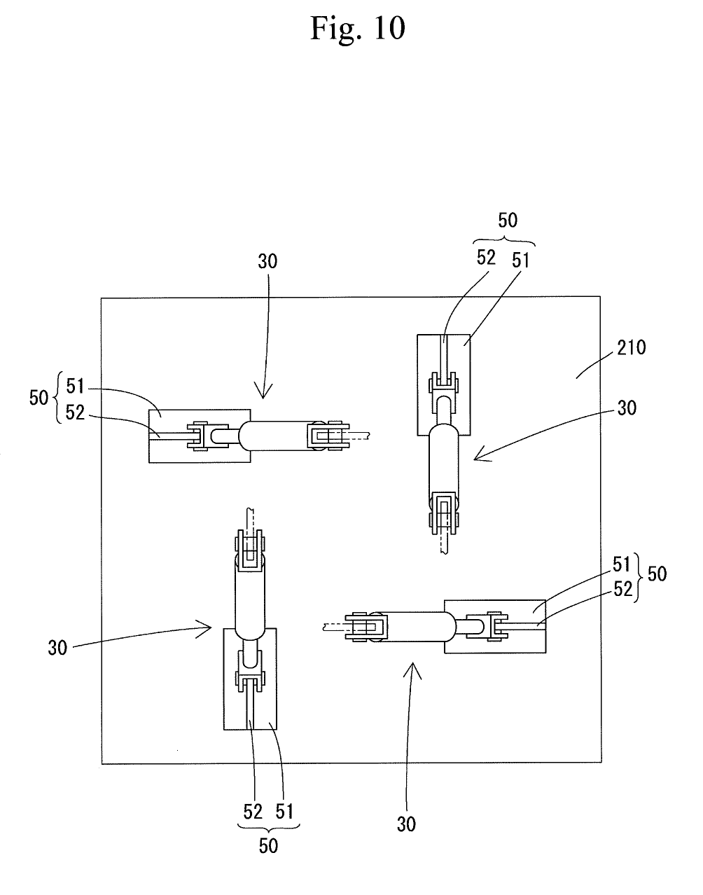

(4) In the first embodiment, the axis lines of the compression dampers 30A extending from the ceiling C side to the top surface 10A side to the top surface 10A side of the furniture 10 extend in opposite directions (two directions) in a planar view as viewed from above. However, as illustrated in FIGS. 9 and 10, the axis lines of the dampers 30 (the compression damper 30A, the extension damper 30B or the bidirectional damper 30R) may extend in different directions in point symmetry. In this case, when the furniture 210 (the article) is tilted in extending directions of the axis lines of the dampers 30A about a point of symmetry, the dampers 30A extend and compress thereby to generate damping forces, damping the forces tilting the furniture 210. Consequently, an amount of tilt of the furniture 210 (the article) is suppressed with the result that the furniture 210 (the article) can be prevented from being overturned. Thus, when a plurality of dampers 30 is mounted so that the axis lines extend in the different directions in point symmetry, the furniture 210 having a square or other horizontal section (the article having a plurality of directions in which the article can be overturned) can desirably be prevented from being overturned.

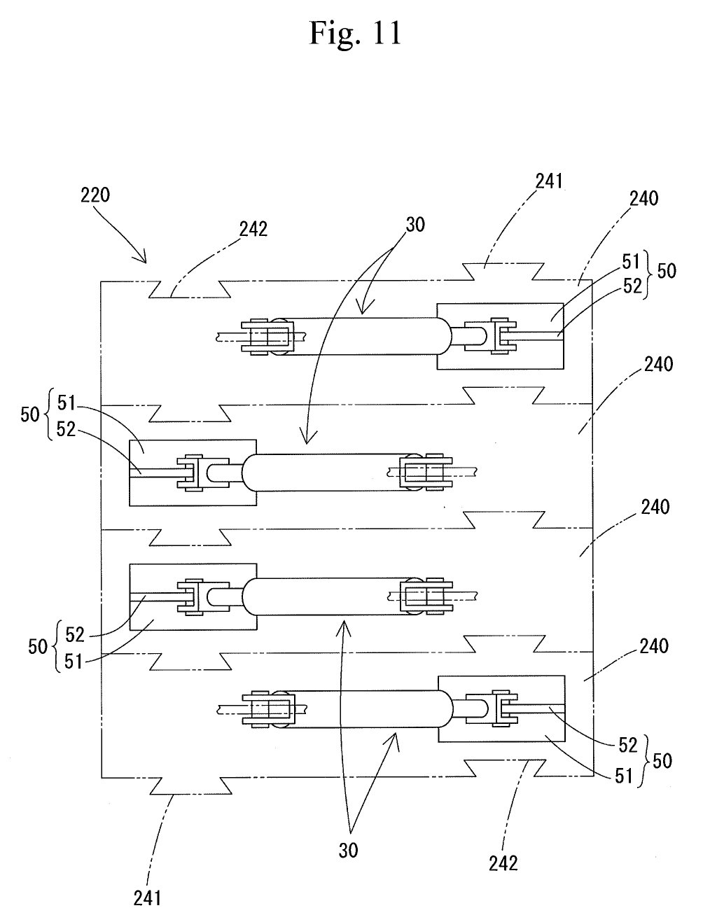

(5) In the first embodiment, the first base 40 includes the first base portion 41 and the paired first connecting portions 42 extending in parallel to each other, and the two compression dampers 30A are connected to the first base 40. However, as illustrated in FIG. 11, the overturn preventing device 220 may comprise a plurality of base plates 240 which are connected to each other and to each of which one damper 30 (the compression damper 30A, the extension damper 30B or the bidirectional damper 30R) is connected. Each base plate 240 is a rectangular flat plate and has two trapezoidal protrusions 241 which are formed on both longer sides so as to be spaced from each other and have spread distal ends, respectively. Each base plate 240 further has two recesses 242 having the same outlines as the protrusions 241. The damper 30 is mounted while being inclined at a predetermined angle in a direction such that an axis line thereof departs from the base plate 240. The protrusions 241 are fitted into the recesses 241 respectively, so that the overturn preventing device 220 provided with a plurality of dampers 30 can be constructed. In this case, the base plates 240 may be combined with each other so that axis lines of the dampers 30 extend in opposite directions as viewed in a planar view from above, or so that the axis lines extend in the same direction.

(6) In the first and second embodiments, the proximal ends of the cylinders 31 of the dampers 30A and 30N are connected to the first bases 40 while the axis lines of the dampers 30A and 30N are inclined relative to the abutting surfaces 41A of the first bases 40 which is brought into surface contact with the ceiling C. However, the distal ends of the rods 33 of the dampers 30A and 30N may be connected to the second bases 50 while the axis lines of the dampers 30A and 30N are inclined relative to the abutting surfaces 51A of the second bases 50 which is brought into surface contact with the top surface 10A of the furniture 10.

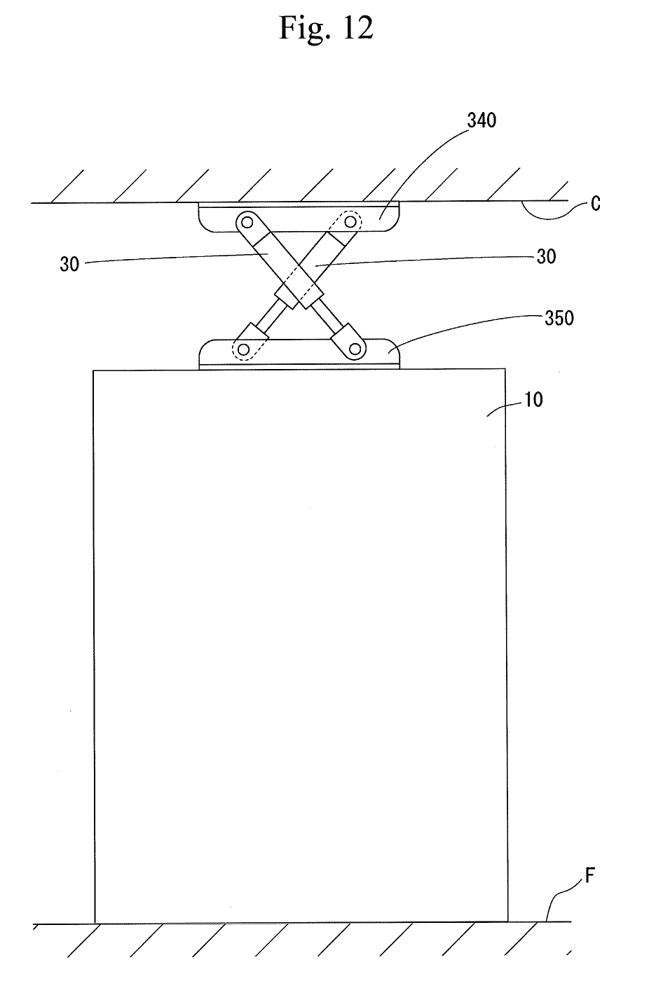

(7) In the first embodiment, the proximal ends of the cylinders of the two compression dampers 30A are connected to one first base 40, and the ends of the reversely extending rods of the compression dampers 30A are connected to the separate second bases 50 respectively. However, as illustrated in FIG. 12, two dampers 30 (the compression dampers 30A, the extension dampers 30N or the bidirectional dampers 30R) may be connected to one first base 340, and the distal ends of rods of the dampers 30 extending while being reversely inclined so as to cross each other as viewed from the right-left direction may be connected to one second base 350. In this case, the overturn preventing device can be mounted between the top surface of the furniture 10 and the ceiling C while the dampers 30 are inclined at a predetermined angle.

(8) Although the first bases 140 are separately provided for three damper units 60A and 60B respectively in the second embodiment, these first bases 140 may be integrated together.

### EXPLANATION OF REFERENCE SYMBOLS

F . . . floor surface (installation surface);
10 . . . furniture (article);
10A . . . top surface of furniture (article);
C . . . ceiling;
30A, 30N and 30R . . . damper (30A . . . compression damper, 30N . . . extension damper and 30R . . . bidirectional damper);
40, 140 and 340 . . . first base (base portion);
41A . . . abutting surface;
50 . . . second base (base portion); and
51A . . . abutting surface

1. An overturn preventing device comprising a plurality of dampers mounted between a top surface of an article installed on an installation surface and a ceiling, wherein:
the dampers are of either a type that has a smaller damping force generated during an extending operation than a damping force generated during a compressing operation or a type that has a larger damping force generated during an extending operation than a damping force generated during a compressing operation; and
the dampers have respective axis lines extending from a ceiling side to the top surface side of the article, the axis lines being downwardly inclined and extending in a plurality of directions in a planar view as viewed from above when the dampers are mounted between the top surface of the article and the ceiling.

2. An overturn preventing device comprising a plurality of dampers mounted between a top surface of an article installed on an installation surface and a ceiling, wherein:
the dampers include a type that has a smaller damping force generated during an extending operation than a damping force generated during a compressing operation and a type that has a larger damping force generated during an extending operation than a damping force generated during a compressing operation; and
the dampers have respective axis lines extending from a ceiling side to the top surface side of the article, the axis lines being downwardly inclined and extending in an identical direction in a planar view as viewed from above when the dampers are mounted between the top surface of the article and the ceiling.

3. An overturn preventing device comprising a plurality of dampers mounted between a top surface of an article installed on an installation surface and a ceiling, wherein:
each damper generates a first damping force during an extending operation and a second damping force during a compressing operation, which first and second damping forces are equal to each other;
the dampers have respective axis lines extending from a ceiling side to the top surface side of the article, the axis lines being downwardly inclined when the dampers are mounted between the top surface of the article and the ceiling.

4. The overturn preventing device according to claim 1, wherein when the dampers are mounted between the top surface of the article and the ceiling, the axis lines extend from the ceiling side to the top surface side of the article in line symmetry.

5. The overturn preventing device according to claim 1, wherein when the dampers are mounted between the top surface of the article and the ceiling, the axis lines extend from the ceiling side to the top surface side of the article in point symmetry.

6. The overturn preventing device according to claim 1, further comprising a base having an abutting surface which is brought into surface contact with the top surface of the article or the ceiling, the base being connected to an end of each damper with the axis line of each damper being inclined relative to the abutting surface.

7. The overturn preventing device according to claim 2, further comprising a base having an abutting surface which is brought into surface contact with the top surface of the article or the ceiling, the base being connected to an end of each damper with the axis line of each damper being inclined relative to the abutting surface.

8. The overturn preventing device according to claim 3, further comprising a base having an abutting surface which is brought into surface contact with the top surface of the article or the ceiling, the base being connected to an end of each damper with the axis line of each damper being inclined relative to the abutting surface.
